(19) United States
(12) Patent Application Publication
(10) Pub. No.: US 2017/0292014 A1
(43) Pub. Date: Oct. 12, 2017

(54) CHLOROPRENE RUBBER COMPOSITION, VULCANIZED MOLDED ARTICLE, AND ANTI-VIBRATION RUBBER

(71) Applicant: DENKA COMPANY LIMITED, Tokyo (JP)

(72) Inventors: Keiji KITAHARA, Itoigawa-city, Niigata (JP); Hiroyuki ISHIGURO, Itoigawa-city, Niigata (JP); Yasushi ABE, Itoigawa-city, Niigata (JP)

(21) Appl. No.: 15/520,720

(22) PCT Filed: Oct. 28, 2014
(86) PCT No.: PCT/JP2014/078583

§ 371 Date: Apr. 20, 2017

(51) Int. Cl. C08L 11/00; C08K 5/00; B29C 35/02; C09C 1/48; C08K 3/22

(52) U.S. Cl. CPC C08L 11/00; C09C 1/48; C08K 3/22; B29C 35/02; C08K 5/0016; C08K 2003/2296

(57) ABSTRACT

Provided is a chloroprene rubber composition giving a vulcanized molded article improved further in heat resistance without deterioration in mechanical properties such as anti-vibration rubber properties, durometer hardness, and elongation at break, a vulcanized molded article prepared and an anti-vibration rubber prepared from the composition. A chloroprene rubber composition, comprising 100 parts by mass of a chloroprene rubber, 0.1 part or more by mass and 10 parts or less by mass of an active zinc white having an average particle diameter of 0.05 μm or more and 0.35 μm or less, a particle diameter range of 0.01 μm or more and 1.0 μm or less and a specific surface area of 10 m²/g or more and 150 m²/g or less, and 15 parts or more by mass and 200 parts or less by mass of a carbon black having an average particle diameter of 70 nm or more and 600 nm or less and a DBP oil absorption number of 15 ml/100 g or more and 60 ml/100 g or less.

### TECHNICAL FIELD

The present invention relates to a chloroprene rubber composition comprising a chloroprene rubber, an active zinc white, and a carbon black. The present technology relates also to a vulcanized molded article obtained by vulcanizing and molding the chloroprene rubber composition and an anti-vibration rubber comprising the vulcanized molded article.

### BACKGROUND ART

Chloroprene rubbers, which are superior in balance in physical properties, for example in mechanical properties, weather resistance, and flame resistance, and can be processed easily, have been used widely as raw materials for various rubber parts for automobiles and also for industrial rubber parts such as belts, hoses, and anti-vibration rubbers. Even in a situation where technology is in rapid progress, there exists a consistent need to improve ozone resistance and heat resistance of industrial rubber parts while keeping their favorable properties such as mechanical properties, weather resistance, and flame resistance. For example, disclosed as a method for improving heat resistance of chloroprene rubber is a method of adding a particular carbon black, zinc powder, and a particular plasticizer to a chloroprene rubber (Patent Document 1). A chloroprene rubber composition which makes it possible to obtain a vulcanized rubber further improved in heat resistance without deterioration in mechanical properties, compression set, and expansion fatigue resistance and also a vulcanized rubber and a rubber part prepared therefrom are disclosed (Patent Document 2). An anti-vibration rubber composition and an anti-vibration rubber which comprise a rubber component and a microparticulate zinc white having a specific surface area in a particular range in order to improve anti-vibration properties of anti-vibration rubbers are disclosed (Patent Document 3).

### CITATION LIST

### Patent Literature

[Patent Document 1] JP-A No. 2005-60581

[Patent Document 2] WO No. 2009/35109

[Patent Document 3] JP-A No. 2006-193621

### SUMMARY OF THE INVENTION

### Technical Problem

It is an object of the present technology to provide a chloroprene rubber composition which gives a vulcanized molded article whose heat resistance is further improved without deterioration in mechanical properties such as anti-vibration rubber properties, durometer hardness, and elongation at break; a vulcanized molded article prepared from the composition; and an anti-vibration rubber prepared from the composition.

### Solution to Problem

In order to achieve the object above, the present inventors conducted intensive studies on the kind, particle diameter, and blending rate of the vulcanizing agent and the particle diameter and blending rate of the carbon black to be added to chloroprene rubber. As a result of the intensive studies, the inventors have found that it is possible to improve heat resistance of a chloroprene rubber composition, a vulcanized molded article, and an anti-vibration rubber prepared from the composition.

Specifically, the present invention provides a chloroprene rubber composition, comprising 100 parts by mass of a chloroprene rubber, 0.1 part or more by mass and 10 parts or less by mass of an active zinc white having an average particle diameter of 0.05 μm or more and 0.35 μm or less, a particle diameter range of 0.01 μm or more and 1.0 μm or less and a specific surface area of 10 m²/g or more and 150 m²/g or less, and 15 parts or more by mass and 200 parts or less by mass of a carbon black having an average particle diameter of 70 nm or more and 600 nm or less and a dibutyl phthalate oil absorption number of 15 ml/100 g or more and 60 ml/100 g or less.

The present invention also provides a vulcanized molded article obtained by vulcanizing and molding the chloroprene rubber composition and an anti-vibration rubber comprising the vulcanized molded article.

The chloroprene rubber may contain a xanthogen-modified chloroprene rubber at a rate of 60 mass % or more and 100 mass % or less and a mercaptan-modified chloroprene rubber at a rate of 0 mass % or more and 40 mass % or less. The chloroprene rubber composition may contain at least one primary aging inhibitor selected from the group consisting of phenol-based aging inhibitors, amine-based aging inhibitors, acrylate-based aging inhibitors, metal carbamate salts, and waxes in an amount of 0.1 part or more by mass and 10 parts or less by mass and at least one secondary aging inhibitor selected from the group consisting of phosphorus-based aging inhibitor, sulfur-based aging inhibitor, and imidazole-based aging inhibitor in an amount of 0.1 part or more by mass and 10 parts or less by mass, and additionally a zinc powder in an amount of 0.1 part or more by mass and 10 parts or less by mass, a plasticizer in an amount of 0.1 part or more by mass and 50 parts or less by mass and a processing aid in an amount of 0.1 part or more by mass and 10 parts or less by mass with respect to 100 parts by mass of the chloroprene rubber contained in the chloroprene rubber composition. The active zinc white may contain zinc at a rate of 20 mass % or more and 98 mass % or less and the particle of the active zinc white may have a composite structure having a core body and a zinc oxide layer covering the surface partially or entirely. The core body of the active zinc white may be made of at least one inorganic salt selected from the group consisting of calcium carbonate, calcium hypochlorite, magnesium carbonate, magnesium oxide, and magnesium hydroxide.

### Advantageous Effects of the Invention

It is possible, by implementing the present invention, to obtain a chloroprene rubber composition which gives a vulcanized molded article superior further in heat resistance without deterioration in mechanical properties, for example, in anti-vibration rubber properties, durometer hardness, and elongation at break. The vulcanized molded article prepared therefrom can be used, for example, as a favorable anti-vibration rubber.

### DESCRIPTION OF EMBODIMENTS

Hereinafter, embodiments of the invention will be described in detail. It should be understood that the present invention is not restricted by the embodiments described below.

The chloroprene rubber composition according to the present invention in the present embodiment comprises a chloroprene rubber (1), an active zinc white (2), and a carbon black (3).

### (1) Chloroprene Rubber

The chloroprene rubber is a product obtained by polymerizing raw monomers containing 2-chloro-1,3-butadiene (hereinafter, referred to as chloroprene), i.e., a homopolymer of chloroprene or a copolymer of chloroprene and other monomers copolymerizable with chloroprene. Examples of the monomers copolymerizable with chloroprene include 2,3-dichloro-1,3-butadiene, 1-chloro-1,3-butadiene, styrene, acrylonitrile, methacrylonitrile, isoprene, butadiene, acrylic acid and methacrylic acid and the esters thereof and the like, and these monomers can be used in the range that satisfies the object of the present invention.

Chloroprene rubbers are classified into mercaptan-, xanthogen-, and sulfur-modified type chloroprene rubbers, depending on the molecular weight modifier used. The mercaptan-modified type chloroprene rubbers are obtained by using an alkylmercaptan such as n-dodecylmercaptan, tert-dodecyloctylmercaptan, or octylmercaptan as the molecular weight modifier. The xanthogen-modified type chloroprene rubbers are obtained by using an alkylxanthogen compound as the molecular weight modifier. The sulfur-modified type chloroprene rubbers are products that are prepared by plasticizing a polymer obtained by copolymerization of sulfur and chloroprene-based monomers with thiuram disulfide to a predetermined Mooney viscosity.

In the present embodiment, among the various chloroprene rubbers, at least one chloroprene rubber selected from the group consisting of xanthogen- and mercaptan-modified chloroprene rubbers can be used. Xanthogen-modified chloroprene rubbers are superior to other modified chloroprene rubbers in mechanical properties such as tensile strength and elongation at break and it is thus possible by using such a xanthogen-modified chloroprene rubber to prepare a chloroprene rubber composition having improved mechanical properties. Mercaptan-modified chloroprene rubbers are superior to other modified chloroprene rubbers in adhesiveness to metals, which rubbers make it possible to prepare a chloroprene rubber composition having improved adhesiveness to metals.

The properties of the chloroprene rubber composition obtained may be properly modified by using these chloroprene rubbers in combination. In particular, in order to preserve and improve heat resistance of the chloroprene rubber composition, it is preferred that a blending rate of a xanthogen-modified chloroprene rubber is 60 mass % or more and 100 mass % or less and a blending rate of a mercaptan-modified chloroprene rubber is 40 mass % or less (0 mass % or more and 40 mass % or less) with respect to 100 mass % of the entire chloroprene rubber.

### (2) Active Zinc White

An active zinc white is added for vulcanization of chloroprene rubbers. A dispersion state of active zinc white particles in the rubber composition and physical properties of a molded vulcanizate of the rubber composition depend on the properties of an active zinc oxide.

The active zinc white used in the present embodiment is characterized in that it has an average particle diameter, as determined under a scanning electron microscope according to JIS Z8901, of 0.05 μm or more and 0.35 μm or less, a particle diameter range of 0.01 μm or more and 1.0 μm or less, and a specific surface area, as determined by BET method according to JIS Z8830 in which nitrogen is used as an adsorbate, of 10 m²/g or more and 150 m²/g or less.

When the active zinc white is very fine particles having an average particle diameter of less than 0.05 μm, containing particles having a diameter of less than 0.01 μm, or having a specific surface area of more than 150 m²/g, the particles aggregate easily and thus become less dispersible. Alternatively when the active zinc white contain large particles having an average particle diameter of more than 0.35 μm, containing particles of more than 1.0 μm, or having a specific surface area of less than 10 m²/g, it becomes less effective as a vulcanizing agent, so that it becomes difficult to improve heat resistance, in any case.

The blending amount of the active zinc white is 0.1 to 10 parts by mass, preferably 1 to 10 parts by mass, more preferably 3 to 5 parts by mass, with respect to 100 parts by mass of the chloroprene rubber. It is possible, by regulating the blending amount of the active zinc white in the range above, to improve the heat resistance of the resulting vulcanized molded article without deterioration in mechanical properties.

The active zinc white preferably has a zinc composition which shows that zinc is contained in an amount of 20 mass % or more and 98 mass % or less, more preferably in an amount of 60 mass % or more and 96 mass % or less, still more preferably in an amount of 90 mass % or more and 94 mass % or less.

The active zinc white preferably contains therein one or both of calcium and magnesium, more preferably both of them, as the components other than zinc. The calcium content in the active zinc white is preferably 1 mass % or more and 30 mass % or less, more preferably 1 to 20 mass %, still more preferably 1 to 10 mass %. The magnesium content in the active zinc white is preferably 0.01 mass % or more and 30 mass % or less, more preferably 0.01 to 10 mass %, still more preferably 0.1 to 5 mass %. The active zinc white may contain H, C, O, Cl, and the like additionally as other elements.

In addition, the active zinc white preferably has a composite structure having a core body and a zinc oxide layer covering the surface thereof partially or entirely. The core body is preferably made of at least one inorganic salt selected from the group consisting of calcium carbonate, calcium hypochlorite, magnesium carbonate, magnesium oxide, and magnesium hydroxide. When an active zinc white having such a structure is used, vulcanization proceeds efficiently, giving a vulcanized molded article and an anti-vibration rubber having favorable properties.

In addition to the active zinc white, one or more metal oxides selected from the group consisting of magnesium oxide, lead oxide, trilead tetraoxide, diiron trioxide, titanium dioxide, calcium oxide, and hydrotalcite may be added as vulcanizing agents. The addition amount of these vulcanizing agents is preferably 1 to 20 parts by mass, more preferably 3 to 15 parts by mass, with respect to 100 parts by mass of the chloroprene rubber.

Further in the present embodiment, a thiourea-, guanidine-, thiuram-, or thiazole-based vulcanization accelerator which is commonly used for vulcanization of the chloroprene rubber may be added in combination with the vulcanizing agents. A thiourea-based vulcanization accelerator is especially preferable among them. Examples of the thiourea-based vulcanization accelerators include ethylene thiourea, diethylthiourea, trimethylthiourea, triethylthiourea, N,N′-diphenylthiourea, and the like. Trimethylthiourea or ethylene thiourea is especially preferable among these thiourea-based vulcanization accelerators. A vulcanization accelerator such as 3-methylthiazolidine-thione-2, a mixture of thiadiazole and phenylenedimaleimide, dimethylammonium hydrogen isophthalate, or a 1,2-dimercapto-1,3,4-thiadiazole derivative may also be used. Two or more of the vulcanization accelerators described above may be used in combination. The addition amount of these vulcanization accelerators is preferably 0.1 to 5 parts by mass, more preferably 0.5 to 5 parts by mass, with respect to 100 parts by mass of the chloroprene rubber.

Further in the present embodiment, a fatty acid or a metal salt thereof such as stearic acid or zinc stearate may be added as an assistant for improving the efficiency of the vulcanization accelerator. The addition amount of these vulcanization acceleration assistants is preferably 0.1 to 5 parts by mass, more preferably 0.5 to 5 parts by mass, with respect to 100 parts by mass of the chloroprene rubber.

### (3) Carbon Black

The carbon black is a reinforcing agent which is added for improving mechanical properties of the vulcanized rubber obtained by vulcanization of the chloroprene rubber composition.

The carbon black is a carbon black having an average particle diameter, as observed under an electron microscope according to JIS Z8901, in the range of 70 nm to 600 nm, preferably in the range of 80 nm to 500 nm, and a dibutyl phthalate (hereinafter, referred to as DBP) oil absorption number, as determined by the oil absorption number method A specified in JIS K6217-4, of 15 ml/100 g to 60 ml/100 g, preferably of 25 ml/100 g to 50 ml/100 g. When the average particle diameter or the DBP oil absorption number is outside the range above, the vulcanized rubber shows deterioration in heat resistance, so that a desired vulcanized molded article or anti-vibration rubber from the chloroprene rubber composition is unobtainable.

The blending amount of the carbon black is in the range of 15 parts or more by mass and 200 parts or less by mass with respect to 100 parts by mass of the chloroprene rubber and may be regulated arbitrarily in the range above according to the desired rubber hardness of the chloroprene rubber composition. It is favorable when the blending amount of the carbon black is 15 to 200 parts by mass with respect to 100 parts by mass of the chloroprene rubber, as it is possible to give a chloroprene rubber composition having improved heat resistance, without excessive hardening, plasticization, or loss of elasticity of the rubber obtained. Further in the present embodiment, a reinforcing agent and/or a filler other than carbon black, such as silica, clay, talc, or calcium carbonate, may be added in combination with the carbon black. The addition amount thereof is arbitrary in the range that does not impair the heat resistance of the chloroprene rubber composition and preferably in the range of 5 to 100 parts by mass with respect to 100 parts by mass of the chloroprene rubber.

In addition to the vulcanizing agent of active zinc white (2) and the reinforcing agent of carbon black (3), a primary aging inhibitor (4), a secondary aging inhibitor (5), a zinc powder (6), a plasticizer (7), and/or a processing aid (8), which are used in conventional chloroprene rubbers, may be properly blended to the chloroprene rubber composition according to the present embodiment, in order to make the vulcanized molded article and anti-vibration rubber of chloroprene rubber show desired physical properties.

### (4) Primary Aging Inhibitor

The primary aging inhibitor is added for prevention of deterioration in durometer hardness, elongation at break, and compression set and for improvement in heat resistance of the vulcanized molded article and the anti-vibration rubber of chloroprene rubber composition when it is heated. Examples of the primary aging inhibitors include phenol-based aging inhibitors, amine-based aging inhibitors, acrylate-based aging inhibitors, metal carbamate salts, and waxes. These primary aging inhibitors may be used alone or in combination of two or more.

Among the primary aging inhibitors above, at least one aging inhibitor selected from the group consisting of phenol-based aging inhibitors, amine-based aging inhibitors, and acrylate-based aging inhibitors is preferable and an amine-based aging inhibitor is more preferable for improvement in heat resistance of the chloroprene rubber composition.

Among the compounds above, an amine-based aging inhibitor 4,4′-bis(α,α-dimethylbenzyl)diphenylamine or an octylated diphenylamine is preferable, as it has a higher heat resistance-improving effect.

The blending amount of the primary aging inhibitor is preferably 0.05 to 15 parts by mass, more preferably 0.1 to 10 parts by mass, more preferably 1 to 10 parts by mass, particularly preferably 2 to 5 parts by mass, with respect to 100 parts by mass of the chloroprene rubber in the chloroprene rubber composition. It is possible, by regulating the blending amount of the primary aging inhibitor in the range above, to prevent deterioration in durometer hardness, elongation at break, and compression set and to improve heat resistance of the vulcanized molded article and the anti-vibration rubber obtained.

### (5) Secondary Aging Inhibitor

The secondary aging inhibitor is added for prevention in deterioration in durometer hardness, elongation at break, and compression set and for improvement in heat resistance of the vulcanized molded article and the anti-vibration rubber of the chloroprene rubber composition when it is heated. Examples of the secondary aging inhibitors include phosphorus-based aging inhibitors, sulfur-based aging inhibitors, and imidazole-based aging inhibitors. These secondary aging inhibitors may be used alone or in combination of two or more.

Among the secondary aging inhibitors above, at least one aging inhibitor selected from the group consisting of phosphorus-based aging inhibitors and sulfur-based aging inhibitors (also referred to as organic thio acid-based aging inhibitors) is preferable and a phosphorus-based aging inhibitor is more preferable for improvement in heat resistance of the chloroprene rubber composition.

Among the compounds above, phosphorus-based aging inhibitors, tris(nonylphenyl) phosphite, and tris(2,4-di-t-butylphenyl) phosphite; sulfur-based aging inhibitors, dilauryl thiodipropionate, dimyristyl-3,3′-thiodipropionate, and distearyl-3,3′-thiodipropionate; and imidazole-based aging inhibitors, 2-mercaptobenzimidazole and 1-benzyl-2-ethylimidazole, are preferable, as they have a higher heat resistance-improving effect.

The blending amount of the secondary aging inhibitor is preferably 0.05 to 15 parts by mass, more preferably 0.1 to 10 parts by mass, more preferably 1 to 10 parts by mass, particularly preferably 2 to 5 parts by mass, with respect to 100 parts by mass of the chloroprene rubber in the chloroprene rubber composition. It is possible, by regulating the blending amount of the secondary aging inhibitor in the range above, to prevent deterioration in durometer hardness, elongation at break, and compression set and to improve the heat resistance of the vulcanized molded article and the anti-vibration rubber obtained.

### (6) Zinc Powder

The zinc powder is added for improvement in heat resistance. Preferably, the zinc powder having an average particle diameter of 2 to 10 μm is used, but not limited to this. The blending amount of the zinc powder is preferably 0.05 to 15 parts by mass, more preferably 0.1 to 10 parts by mass, more preferably 0.5 to 10 parts by mass, particularly preferably 3 to 5 parts by mass, with respect to 100 parts by mass of the chloroprene rubber. It is possible, by regulating the blending amount of the zinc powder in the range above, to prevent deterioration in durometer hardness, elongation at break, and compression set and to improve heat resistance of the vulcanized molded article and the anti-vibration rubber obtained.

### (7) Plasticizer

Any plasticizer can be added to the chloroprene rubber composition, as long as it is compatible with the chloroprene rubber. Examples thereof include vegetable oils such as rape-seed oil, phthalate-based plasticizers, DUP (diundecyl phthalate), DOS (dioctyl sebacate), DOA (dioctyl adipate), ester-based plasticizers, ether/ester-based plasticizers, thioether-based plasticizers, aromatic oils, naphthene-based oils, and the like. These plasticizers may be used alone or in combination of two or more according to properties demanded for the chloroprene rubber composition. The blending amount of the plasticizer is preferably 3 to 50 parts by mass, more preferably 5 to 50 parts by mass, still more preferably 5 to 30 parts by mass, with respect to 100 parts by mass of the chloroprene rubber.

### (8) Processing Aid

A processing aid is added in order to improve processing properties, for example to make the chloroprene rubber composition easily separable from rolls, molds, extruder screws, and the like. Examples of the processing aid include fatty acids such as stearic acid, paraffin-based processing aids such as polyethylene, fatty acid amides and the like. These processing aids can be added in an amount of 0.5 to 5 parts by mass with respect to 100 parts by mass of the chloroprene rubber.

The chloroprene rubber composition is prepared by blending and kneading a chloroprene rubber with these additives (2) to (8) at a temperature of the vulcanization temperature or lower. Examples of the apparatuses for blending and kneading the chloroprene rubber composition include known kneading apparatuses such as mixers, banbury mixers, kneader mixers, and open rolls.

The chloroprene rubber composition according to the present embodiment comprises an active zinc white having a particle diameter and a specific surface area in particular ranges and a carbon black having a particle diameter and an oil absorption number in particular ranges as described above. Therefore, the chloroprene rubber composition can give a molded vulcanizate whose heat resistance is further improved without deterioration in anti-vibration rubber properties and mechanical properties such as durometer hardness and elongation at break.

The vulcanized molded article according to the present embodiment of the present invention is obtained by vulcanizing and molding the chloroprene rubber composition described above. The vulcanized molded article in the present embodiment can be obtained by vulcanizing and molding the chloroprene rubber composition described above into a desired shape. A method for vulcanizing and molding the chloroprene rubber composition into a desired shape is not limited to any specific method. The chloroprene rubber composition may be molded into a desired shape before vulcanization, or the chloroprene rubber composition may be vulcanized to prepare a vulcanized rubber and then the vulcanized rubber may be molded into a desired shape. Alternatively, the chloroprene rubber composition may be vulcanized while being molded.

The chloroprene rubber composition described above may be molded into an arbitrary desired shape before vulcanization, or the chloroprene rubber composition may be vulcanized to prepare a vulcanized rubber before the vulcanized rubber may be molded into an arbitrary shape. As a method for molding the chloroprene rubber composition or the vulcanized rubber, conventional methods, such as press molding, extrusion molding, calendering molding, and other methods may be adopted. These methods may be those routinely used in the rubber industry.

The chloroprene rubber composition can be vulcanized to obtain a vulcanized rubber by common steam vulcanization or UHF vulcanization, but not limited to these methods. The steam vulcanization is a method of vulcanizing an unvulcanized chloroprene rubber composition under the pressure and heat supplied by a steam gas, which is used as heat medium, while the UHF vulcanization is a method of vulcanizing a chloroprene rubber composition by irradiation of microwave. It is also possible to vulcanize a chloroprene rubber composition by holding a chloroprene rubber composition in a mold and raising the mold temperature to the vulcanization temperature during press vulcanization or injection molding. The vulcanization temperature can be designed properly depending on the composition of the chloroprene rubber composition and the kind of the vulcanizing agent and is preferably in the range of 140 to 220° C., more preferably in the range of 150 to 180° C., in most cases.

The vulcanized molded article according to the present embodiment comprises a chloroprene rubber composition containing an active zinc white having a particle diameter and a specific surface area in particular ranges and a carbon black having a particle diameter and an oil absorption number in particular ranges. Therefore, the vulcanized molded article is superior in mechanical properties and heat resistance and also in anti-vibration rubber properties. Thus, the vulcanized molded article according to the present embodiment is suitable as an anti-vibration rubber.

### EXAMPLES

Hereinafter, the present invention will be described more in detail with reference to Examples, but it should be understood that it is not restricted thereby. In the Examples below, chloroprene rubber compositions having different component compositions were prepared and the properties of vulcanized molded articles obtained therefrom were evaluated.

### Examples 1 to 38

A chloroprene rubber, a carbon black, a primary aging inhibitor, a secondary aging inhibitor, zinc powder, magnesium oxide, a plasticizer, and stearic acid were mixed at a particular blending ratio according to the blending compositions shown in Tables 1 to 3, and each mixture was kneaded in a pressure kneader test machine. An active zinc white and ethylene thiourea were added to the kneaded blend prepared in the kneader test machine at a particular blending ratio, and the mixture was mixed and kneaded further using 8-inch-diameter twin open rolls, to obtain a chloroprene rubber composition sheet having a thickness of 2.3 mm.

TABLE 1

| | | | Example | | | | | | | | | | | | | |
|---|---|---|---|---|---|---|---|---|---|---|---|---|---|---|---|---|
| | Component | | 1 | 2 | 3 | 4 | 5 | 6 | 7 | 8 | 9 | 10 | 11 | 12 | 13 | 14 |
| Composition | Xanthogen-modified | | 100 | 80 | 60 | 40 | 100 | 100 | 100 | 100 | 100 | 100 | 100 | 100 | 100 | 100 |
| (parts by | CR | | | | | | | | | | | | | | | |
| mass | Mercaptan-modified | | 0 | 20 | 40 | 60 | 0 | 0 | 0 | 0 | 0 | 0 | 0 | 0 | 0 | 0 |
| | CR | | | | | | | | | | | | | | | |
| | Active zinc white | A | — | — | — | — | — | — | — | — | — | — | — | — | — | — |
| | | B | 5 | 5 | 5 | 5 | — | 5 | 5 | 5 | 5 | 5 | 5 | 5 | 0.1 | 10 |
| | | C | — | — | — | — | 5 | — | — | — | — | — | — | — | — | — |
| | Magnesium oxide | | 4 | 4 | 4 | 4 | 4 | 4 | 4 | 4 | 4 | 4 | 4 | 4 | 4 | 4 |
| | Ethylene thiourea | | 1 | 1 | 1 | 1 | 1 | 1 | 1 | 1 | 1 | 1 | 1 | 1 | 1 | 1 |
| | Carbon black | A | 40 | 40 | 40 | 40 | 40 | — | — | 40 | 40 | 40 | 40 | 40 | 40 | 40 |
| | | B | — | — | — | — | — | 40 | — | — | — | — | — | — | — | — |
| | | C | — | — | — | — | — | — | 40 | — | — | — | — | — | — | — |
| | | D | — | — | — | — | — | — | — | — | — | — | — | — | — | — |
| | Primary | A | — | — | — | — | — | — | — | 5 | — | — | — | — | — | — |
| | aging inhibitor | B | 5 | 5 | 5 | 5 | 5 | 5 | 5 | — | — | 5 | 5 | 5 | 5 | 5 |
| | | C | — | — | — | — | — | — | — | — | 5 | — | — | — | — | — |
| | Secondary | A | — | — | — | — | — | — | — | — | — | 2 | — | — | — | — |
| | aging inhibitor | B | 2 | 2 | 2 | 2 | 2 | 2 | 2 | 2 | 2 | — | 2 | 2 | 2 | 2 |
| | Zinc powder | | 5 | 5 | 5 | 5 | 5 | 5 | 5 | 5 | 5 | 5 | 5 | 5 | 5 | 5 |
| | Plasticizer | A | — | — | — | — | — | — | — | — | — | — | 10 | — | — | — |
| | | B | 10 | 10 | 10 | 10 | 10 | 10 | 10 | 10 | 10 | 10 | — | — | 10 | 10 |
| | | C | — | — | — | — | — | — | — | — | — | — | — | 10 | — | — |

| | | | | | | | | | | | | | | |
|---|---|---|---|---|---|---|---|---|---|---|---|---|---|---|
| Stearic acid | 0.5 | 0.5 | 0.5 | 0.5 | 0.5 | 0.5 | 0.5 | 0.5 | 0.5 | 0.5 | 0.5 | 0.5 | 0.5 | 0.5 |

TABLE 2

| | | | Example | | | | | | | | |
|---|---|---|---|---|---|---|---|---|---|---|---|
| | Component | | 15 | 16 | 17 | 18 | 19 | 20 | 21 | 22 | 23 |
| Composition | Xanthogen-modified | | 100 | 100 | 100 | 100 | 100 | 100 | 100 | 100 | 100 |
| (parts by | CR | | | | | | | | | | |
| mass) | Mercaptan-modified | | 0 | 0 | 0 | 0 | 0 | 0 | 0 | 0 | 0 |
| | CR | | | | | | | | | | |
| | Active zinc white | A | — | — | — | — | — | — | — | — | — |
| | | B | 5 | 5 | 5 | 5 | 5 | 5 | 5 | 5 | 5 |
| | | C | — | — | — | — | — | — | — | — | — |
| | Magnesium oxide | | 4 | 4 | 4 | 4 | 4 | 4 | 4 | 4 | 4 |
| | Ethylene thiourea | | 1 | 1 | 1 | 1 | 1 | 1 | 1 | 1 | 1 |
| | Carbon black | A | 40 | 40 | 40 | 40 | 40 | 40 | 40 | 40 | 40 |
| | | B | — | — | — | — | — | — | — | — | — |
| | | C | — | — | — | — | — | — | — | — | — |
| | | D | — | — | — | — | — | — | — | — | — |
| | Primary | A | — | — | — | — | — | — | — | — | — |
| | aging inhibitor | B | 0.05 | 0.1 | 10 | 15 | 5 | 5 | 5 | 5 | 5 |
| | | C | — | — | — | — | — | — | — | — | — |
| | Secondary | A | — | — | — | — | — | — | — | — | — |
| | aging inhibitor | B | 2 | 2 | 2 | 2 | 0.05 | 0.1 | 10 | 15 | 2 |
| | Zinc powder | | 5 | 5 | 5 | 5 | 5 | 5 | 5 | 5 | 0.05 |
| | Plasticizer | A | — | — | — | — | — | — | — | — | — |
| | | B | 10 | 10 | 10 | 10 | 10 | 10 | 10 | 10 | 10 |
| | | C | — | — | — | — | — | — | — | — | — |

| | | | | | | | | | |
|---|---|---|---|---|---|---|---|---|---|
| Stearic acid | 0.5 | 0.5 | 0.5 | 0.5 | 0.5 | 0.5 | 0.5 | 0.5 | 0.5 |

| | | Example | | | | | | | |
|---|---|---|---|---|---|---|---|---|---|
| | Component | 24 | 25 | 26 | 27 | 28 | 29 | 30 | 31 |
| Composition | Xanthogen-modified | 100 | 100 | 100 | 100 | 100 | 100 | 100 | 100 |
| (parts by | CR | | | | | | | | |
| mass) | Mercaptan-modified | 0 | 0 | 0 | 0 | 0 | 0 | 0 | 0 |
| | CR | | | | | | | | |

| | Active zinc white | A | — | — | — | — | — | — | — | — |
|---|---|---|---|---|---|---|---|---|---|---|
| | | B | 5 | 5 | 5 | 5 | 5 | 5 | 5 | 5 |
| | | C | — | — | — | — | — | — | — | — |
| | Magnesium oxide | | 4 | 4 | 4 | 4 | 4 | 4 | 4 | 4 |
| | Ethylene thiourea | | 1 | 1 | 1 | 1 | 1 | 1 | 1 | 1 |
| Carbon black | | A | 40 | 40 | 40 | 40 | 40 | 40 | 15 | 200 |
| | | B | — | — | — | — | — | — | — | — |
| | | C | — | — | — | — | — | — | — | — |
| | | D | — | — | — | — | — | — | — | — |
| Primary | | A | — | — | — | — | — | — | — | — |
| aging inhibitor | | B | 5 | 5 | 5 | 5 | 5 | 5 | 5 | 5 |
| | | C | — | — | — | — | — | — | — | — |
| Secondary | | A | — | — | — | — | — | — | — | — |
| aging inhibitor | | B | 2 | 2 | 2 | 2 | 2 | 2 | 2 | 2 |
| | Zinc powder | | 0.1 | 10 | 15 | 5 | 5 | 5 | 5 | 5 |
| | Plasticizer | A | — | — | — | — | — | — | — | — |
| | | B | 10 | 10 | 10 | 3 | 5 | 30 | 10 | 50 |
| | | C | — | — | — | — | — | — | — | — |

| | | | | | | | | |
|---|---|---|---|---|---|---|---|---|
| Stearic acid | 0.5 | 0.5 | 0.5 | 0.5 | 0.5 | 0.5 | 0.5 | 0.5 |

TABLE 3

| | | | Example | | | | | | |
|---|---|---|---|---|---|---|---|---|---|
| | Component | | 32 | 33 | 34 | 35 | 36 | 37 | 38 |
| Composition | Xanthogen-modified | | 100 | 100 | 100 | 100 | 100 | 100 | 100 |
| (parts by | CR | | | | | | | | |
| mass) | Mercaptan-modified | | 0 | 0 | 0 | 0 | 0 | 0 | 0 |
| | CR | | | | | | | | |
| | Active zinc white | A | 5 | — | — | — | — | — | 5 |
| | | B | — | 0.05 | 15 | 5 | 5 | 5 | — |
| | | C | — | — | — | — | — | — | — |
| | Magnesium oxide | | 4 | 4 | 4 | 4 | 4 | 4 | 4 |
| | Ethylene thiourea | | 1 | 1 | 1 | 1 | 1 | 1 | 1 |
| | Carbon black | A | 40 | 40 | 40 | — | 10 | 250 | 40 |
| | | B | — | — | — | — | — | — | — |
| | | C | — | — | — | — | — | — | — |
| | | D | — | — | — | 40 | — | — | — |
| | Primary | A | — | — | — | — | — | — | — |
| | aging inhibitor | B | 5 | 5 | 5 | 5 | 5 | 5 | 5 |
| | | C | — | — | — | — | — | — | — |
| | Secondary | A | — | — | — | — | — | — | — |
| | aging inhibitor | B | 2 | 2 | 2 | 2 | 2 | 2 | — |
| | Zinc powder | | 5 | 5 | 5 | 5 | 5 | 5 | — |
| | Plasticizer | A | — | — | — | — | — | — | 10 |
| | | B | 10 | 10 | 10 | 10 | 10 | 50 | — |
| | | C | — | — | — | — | — | — | — |

| | | | | | | | |
|---|---|---|---|---|---|---|---|
| Stearic acid | 0.5 | 0.5 | 0.5 | 0.5 | 0.5 | 0.5 | 0.5 |

The xanthogen-modified chloroprene rubber shown in Tables 1 to 3 above is DCR-66 (product name, manufactured by Denka Company Limited), and the mercaptan-modified chloroprene rubber is DCR-36 (product name, manufactured by Denka Company Limited).

The active zinc white A is Zinc Oxide No.2 (product name, produced by Sakai Chemical Industry, average particle diameter: 1.38 μm, particle diameter range: 0.45 to 5.87 μm, specific surface area: 3.2 m²/g); the active zinc white B is Active Zinc White META-Z102 (product name, produced by Inoue Calcium Corporation, average particle diameter: 0.19 μm, particle diameter range: 0.10 to 0.30 μm, specific surface area: 11.6 m²/g); and the active zinc white C is Active Zinc White AZO (product name, produced by Seido Chemical Industry, average particle diameter: 0.12 μm, particle diameter range: 0.04 to 0.44 μm, specific surface area: 72 m²/g).

The carbon black A is Thermax N-990 (product name, produced by Cancarb, average particle diameter: 450 nm, DBP oil absorption number: 44 ml/100 g); the carbon black B is Asahi #22K (produced by Asahi Carbon, average particle diameter: 80 nm, DBP oil absorption number: 26 ml/100 g); the carbon black C is Asahi Thermal (produced by Asahi Carbon, average particle diameter: 80 nm, DBP oil absorption number: 28 ml/100 g); and the carbon black D is SEAST SO (produced by Tokai Carbon, average particle diameter: 43 nm, DBP oil absorption number: 115 ml/100 g).

The primary aging inhibitor A is tetrakis[methylene(3,5-di-tert-butyl-4-hydroxyhydrocinnamate)]methane, i.e., Irganox 1010 (product name, produced by BASF); the primary aging inhibitor B is 4,4′-bis(α,α-dimethylbenzyl)diphenylamine, i.e., Nocrac CD (product name, produced by Ouchi Shinko Chemical Industrial); and the primary aging inhibitor C is 2-tert-butyl-6-(3-tert-butyl-2-hydroxy-5-methylbenzyl)-4-methylphenyl acrylate, i.e., Sumilizer GM (product name, produced by Sumitomo Chemical).

The secondary aging inhibitor A is dilauryl thiodipropionate, i.e., Nocrac 400 (product name, produced by Ouchi Shinko Chemical Industrial); the secondary aging inhibitor B is tris(nonylphenyl) phosphite, i.e., Nocrac TNP (product name, produced by Ouchi Shinko Chemical Industrial).

The Plasticizer A is bis(2-ethylhexyl) sebacate, i.e., Sansocizer DOS (product name, produce by New Japan Chemical); the plasticizer B is diundecyl phthalate, i.e., Sansocizer DUP (product name, produced by New Japan Chemical); and the plasticizer C is an ether/ester-based plasticizer.

Commercially available magnesium oxide, ethylene thiourea, zinc powder, and stearic acid were used.

The average particle diameter and also the maximum and minimum particle diameters of the active zinc whites used in these Examples were determined by the microscopic observation method according to JIS Z8901. Specifically, an active zinc white was diluted with water and the mixture was dispersed by ultrasonication and air dried, to give a sample. The sample was observed under a scanning electron microscope (FE-SEM SU6600; manufactured by Hitachi High-Technologies Corporation), the circle-equivalent diameters of 200 particles were determined on the micrograph and the arithmetic mean thereof was used as the average particle diameter and the particle diameter range was determined from the maximum and minimum values.

The specific surface area of the active zinc white was determined by the BET method according to JIS Z8830 in which nitrogen was used as an adsorbate. Specifically, an active zinc white was diluted with water and the mixture was dispersed by ultrasonication and air dried, to give a sample. The specific surface area of the sample was determined on a specific surface area analyzer (Monosorb, manufactured by Quantachrome Instruments).

As for the chemical composition of the active zinc white, the active zinc white was dried in a drier at 70° C. for 12 hours and the sample was pulverized and then, the elements contained in the active zinc white were quantified by a fluorescent X-ray analyzer (ZSX100e, manufactured by Rigaku Corporation). The chemical compositions of active zinc whites A to C thus obtained are shown in the following Table 4.

TABLE 4

| | | Active zinc | Active zinc | Active zinc |
|---|---|---|---|---|
| Element | | white A | white B | white C |
| name | Unit | Zinc oxide #2 | META-Z102 | AZO |
| Zinc | mass % | 99.8 | 92.3 | 92.1 |
| Calcium | mass % | — | 4.7 | — |
| Magnesium | mass % | — | 0.3 | — |
| Others | mass % | 0.2 | 2.7 | 7.9 |
| Total | mass % | 100 | 100 | 100 |

Vulcanized molded articles of the chloroprene rubber compositions were evaluated using test pieces prepared by the following method. Specifically, a chloroprene rubber composition sheet obtained was vulcanized at 160° C. for 20 minutes under a pressure of 0.8 MPa, to obtain a vulcanized molded article sheet having a thickness of 2.0 mm. Using the vulcanized molded article sheet, the durometer hardness (Hs) (1) and the elongation at break (EB) (2) of the test piece were determined immediately after the vulcanization molding, and after the aging-accelerating process in which the test piece was placed under an aging-accelerating environment of 100° C. (gear-type aging test machine GPHH-type 201, manufactured by ESPEC Corp., was used.) for 1000 hours according to method A of JIS K6257. In addition, the test piece was press-vulcanized under a condition of 160° C.×30 minutes and a pressure of 0.8 MPa, to give a cylindrical test piece of the vulcanized molded article having a diameter of 29.0 mm and a thickness of 12.5 mm. The anti-vibration rubber properties (dynamic magnification, Kd/Ks) (3) of the cylindrical test piece immediately after vulcanization molding and the compression set (CS) (4) thereof after aging acceleration treatment were determined. Based on these measured values, fundamental properties for anti-vibration rubber and change in rubber physical properties between before and after the heat aging acceleration treatment, i.e., heat resistance, were evaluated.

The durometer hardness (1) was determined according to JIS K6253-3, at 23° C., and under the condition that three sheets of the vulcanized molded article sheets were stacked. The hardness meter used was Asker Rubber Durometer type A, manufactured by Kobunshi Keiki.

The elongation at break (2) was determined according to JIS K6251. A dumbbell-shaped #3 test piece was cut off from the vulcanized molded article sheet and the elongation at break thereof was determined using a full automatic rubber tensile tester (AGS-H, manufactured by Shimadzu Corporation) under a condition of 23° C. and a tension speed of 500 mm/minute.

As for the anti-vibration rubber properties (3), a dynamic spring constant (Kd) and a static spring constant (Ks) of the cylindrical test piece were determined at 23° C. under the general test condition specified in JIS K6386 and the dynamic magnification (Kd/Ks) was calculated therefrom. The analyzer used was a dynamic characteristics test machine (KCH701-20, manufactured by Saginomiya Seisakusho).

The compression set (4) was evaluated according to JIS K6262, using the vulcanized cylindrical. The test piece was compressed under a condition of 100° C., a compression period of 1000 hours, and a thickness of the spacer for the compression testing machine of 9.38 mm. The thickness of the test piece after compression was determined using a thickness gauge (Asker Test piece Thickness Meter type SDA-25, manufactured by Kobunshi Keiki) and the compression set was calculated.

The evaluation results are shown in Tables 1 to 3. When a vulcanized molded rubber article functions as an anti-vibration rubber, its dynamic magnification (Kd/Ks) is required to be 1.4 or less. It was considered that, in order to solve the conventional problems concerning the heat resistance of anti-vibration rubber, the change of durometer hardness (increase of point) between before and after aging acceleration treatment should be 10 or less, the change of elongation at break (decrease of %) be 10 or less, and the compression set after aging acceleration treatment be 40% or less.

TABLE 5

| | | | Example | | | | | | |
|---|---|---|---|---|---|---|---|---|---|
| | Item evaluated | | 1 | 2 | 3 | 4 | 5 | 6 | 7 |
| Evaluation | Durometer hardness | Immediately after | 48 | 48 | 48 | 48 | 48 | 48 | 48 |
| results | Hs (point) | vulcanization molding | | | | | | | |
| | | After aging acceleration treatment | 52 | 52 | 52 | 55 | 52 | 54 | 54 |
| | | Change between before and after | +4 | +4 | +4 | +7 | +4 | +6 | +6 |
| | | aging acceleration treatment | | | | | | | |
| | Elongation at break | Immediately after | 471 | 452 | 433 | 420 | 455 | 441 | 426 |
| | EB (%) | vulcanization molding | | | | | | | |
| | | After aging acceleration treatment | 470 | 451 | 430 | 412 | 454 | 438 | 422 |
| | | Change between before and after | −1 | −1 | −3 | −8 | −1 | −3 | −4 |
| | | aging acceleration treatment | | | | | | | |
| | Anti-vibration rubber | Immediately after | 1.30 | 1.31 | 1.32 | 1.36 | 1.31 | 1.31 | 1.33 |
| | properties | vulcanization molding | | | | | | | |
| | (Kd/Ks) | | | | | | | | |
| | Compression set | After aging acceleration treatment | 35 | 36 | 37 | 39 | 36 | 36 | 37 |
| | CS (%) | | | | | | | | |
| | | | Example | | | | | | |
| | Item evaluated | | 8 | 9 | 10 | 11 | 12 | 13 | 14 |
| Evaluation | Durometer hardness | Immediately after | 48 | 48 | 47 | 48 | 48 | 48 | 48 |
| results | Hs (point) | vulcanization molding | | | | | | | |
| | | After aging acceleration treatment | 52 | 53 | 51 | 54 | 52 | 53 | 53 |
| | | Change between before and after | +4 | +5 | +4 | +6 | +4 | +5 | +5 |
| | | aging acceleration treatment | | | | | | | |
| | Elongation at break | Immediately after | 448 | 442 | 473 | 460 | 493 | 511 | 482 |
| | EB (%) | vulcanization molding | | | | | | | |
| | | After aging acceleration treatment | 446 | 439 | 471 | 457 | 492 | 507 | 480 |
| | | Change between before and after | −2 | −3 | −2 | −3 | −1 | −4 | −2 |
| | | aging acceleration treatment | | | | | | | |
| | Anti-vibration rubber | Immediately after | 1.32 | 1.33 | 1.31 | 1.29 | 1.34 | 1.33 | 1.32 |
| | properties | vulcanization molding | | | | | | | |
| | (Kd/Ks) | | | | | | | | |
| | Compression set | After aging acceleration treatment | 37 | 37 | 34 | 37 | 35 | 36 | 33 |
| | CS (%) | | | | | | | | |

TABLE 6

| | | | Example | | | | | | | |
|---|---|---|---|---|---|---|---|---|---|---|
| | Item evaluated | | 15 | 16 | 17 | 18 | 19 | 20 | 21 | 22 |
| Evaluation | Durometer hardness | Immediately after | 48 | 48 | 48 | 48 | 48 | 48 | 46 | 45 |
| results | Hs (point) | vulcanization molding | | | | | | | | |
| | | After aging acceleration treatment | 57 | 55 | 52 | 52 | 56 | 54 | 49 | 47 |
| | | Change between before and after | +9 | +7 | +4 | +4 | +8 | +6 | +3 | +2 |
| | | aging acceleration treatment | | | | | | | | |
| | Elongation at break | Immediately after | 456 | 452 | 447 | 433 | 437 | 446 | 463 | 489 |
| | EB (%) | vulcanization molding | | | | | | | | |
| | | After aging acceleration treatment | 447 | 445 | 445 | 432 | 428 | 439 | 461 | 488 |
| | | Change between before and after | −9 | −7 | −2 | −1 | −9 | −7 | −2 | −1 |
| | | aging acceleration treatment | | | | | | | | |
| | Anti-vibration rubber | Immediately after | 1.31 | 1.32 | 1.34 | 1.38 | 1.32 | 1.30 | 1.35 | 1.38 |
| | properties | vulcanization molding | | | | | | | | |
| | (Kd/Ks) | | | | | | | | | |
| | Compression set | After aging acceleration treatment | 39 | 36 | 33 | 33 | 37 | 36 | 34 | 32 |
| | CS (%) | | | | | | | | | |

| | | | Example | | | | | | | | |
|---|---|---|---|---|---|---|---|---|---|---|---|
| | Item evaluated | | 23 | 24 | 25 | 26 | 27 | 28 | 29 | 30 | 31 |
| Evaluation | Durometer | Immediately after | 48 | 48 | 49 | 49 | 54 | 53 | 30 | 44 | 75 |
| results | hardness | vulcanization molding | | | | | | | | | |
| | Hs (point) | After aging acceleration treatment | 51 | 54 | 52 | 52 | 60 | 58 | 35 | 52 | 82 |
| | | Change between before and after | +3 | +6 | +3 | +3 | +6 | +5 | +5 | +8 | +7 |
| | | aging acceleration treatment | | | | | | | | | |
| | Elongation at | Immediately after | 475 | 470 | 438 | 420 | 410 | 418 | 501 | 751 | 203 |
| | break EB (%) | vulcanization molding | | | | | | | | | |
| | | After aging acceleration treatment | 467 | 463 | 436 | 418 | 401 | 412 | 493 | 742 | 195 |
| | | Change between before and after | −8 | −7 | −2 | −2 | −9 | −6 | −8 | −9 | −8 |
| | | aging acceleration treatment | | | | | | | | | |
| | Anti-vibration | Immediately after | 1.31 | 1.30 | 1.32 | 137 | 1.30 | 1.29 | 1.36 | 1.28 | 1.39 |
| | rubber properties | vulcanization molding | | | | | | | | | |
| | (Kd/Ks) | | | | | | | | | | |
| | Compression set | After aging acceleration treatment | 37 | 36 | 33 | 31 | 38 | 31 | 38 | 38 | 39 |
| | CS (%) | | | | | | | | | | |

TABLE 7

| | | | Example | | | | | | |
|---|---|---|---|---|---|---|---|---|---|
| | Item evaluated | | 32 | 33 | 34 | 35 | 36 | 37 | 38 |
| Evaluation | Durometer | Immediately after | 48 | 48 | 50 | 54 | 41 | 90 | 47 |
| results | hardness | vulcanization molding | | | | | | | |
| | Hs (point) | After aging acceleration treatment | 58 | 63 | 61 | 62 | 52 | 96 | 56 |
| | | Change between before and after | +10 | +15 | +11 | +8 | +11 | +6 | +9 |
| | | aging acceleration treatment | | | | | | | |
| | Elongation at | Immediately after | 466 | 520 | 411 | 430 | 542 | 173 | 549 |
| | break | vulcanization molding | | | | | | | |
| | EB (%) | After aging acceleration treatment | 451 | 500 | 401 | 417 | 529 | 166 | 531 |
| | | Change between before and after | −15 | −20 | −10 | −13 | −13 | −7 | −18 |
| | | aging acceleration treatment | | | | | | | |
| | Anti- | Immediately after | 1.35 | 1.45 | 1.29 | 1.50 | 1.33 | 1.83 | 1.31 |
| | vibration | vulcanization molding | | | | | | | |
| | rubber | | | | | | | | |
| | properties | | | | | | | | |
| | (Kd/Ks) | | | | | | | | |
| | Compression | After aging acceleration treatment | 36 | 40 | 35 | 41 | 41 | 50 | 39 |
| | set CS (%) | | | | | | | | |

The results in Tables 5 to 7 show that, in Examples 1 to 31, a chloroprene rubber composition that gave a vulcanized molded rubber article whose heat resistance was further improved without deterioration in mechanical properties, compression set, expansion fatigue resistance, and anti-vibration properties, and a vulcanized molded article and an anti-vibration rubber of the composition were obtained, indicating the advantageous effects of the present invention.

1. A chloroprene rubber composition, comprising
100 parts by mass of a chloroprene rubber,
0.1 part or more by mass and 10 parts or less by mass of an active zinc white having an average particle diameter of 0.05 μm or more and 0.35 μm or less, a particle diameter range of 0.01 μm or more and 1.0 μm or less and a specific surface area of 10 m²/g or more and 150 m²/g or less, and
15 parts or more by mass and 200 parts or less by mass of a carbon black having an average particle diameter of 70 nm or more and 600 nm or less and a DBP oil absorption number of 15 ml/100 g or more and 60 ml/100 g or less.

2. The chloroprene rubber composition according to claim 1, wherein the chloroprene rubber contains 60 mass % or more and 100 mass % or less of a xanthogen-modified chloroprene rubber and 0 mass % or more and 40 mass % or less of a mercaptan-modified chloroprene rubber.

3. The chloroprene rubber composition according to claim 1, further comprising,
with respect to 100 parts by mass of the chloroprene rubber,
0.1 part or more by mass and 10 parts or less by mass of at least one primary aging inhibitor selected from the group consisting of phenol-based aging inhibitors, amine-based aging inhibitors, acrylate-based aging inhibitors, metal carbamate salts, and waxes,
0.1 part or more by mass and 10 parts or less by mass of at least one secondary aging inhibitor selected from the group consisting of phosphorus-based aging inhibitors, sulfur-based aging inhibitors, and imidazole-based aging inhibitors, and 0.1 part or more by mass and 10 parts or less by mass of a zinc powder.

4. The chloroprene rubber composition according to claim 1, further comprising a plasticizer in an amount of 5 parts or more by mass and 50 parts or less by mass with respect to 100 parts by mass of the chloroprene rubber.

5. The chloroprene rubber composition according to claim 1, wherein the active zinc white has a chemical composition which shows that zinc is contained in an amount of 20 mass % or more and 98 mass % or less.

6. The chloroprene rubber composition according to claim 1, wherein the active zinc white has a chemical composition which shows that zinc is contained in an amount of 20 mass % or more and 98 mass % or less, calcium is contained in an amount of 1 mass % or more and 30 mass % or less, and magnesium is contained in an amount of 0.01 mass % or more and 30 mass % or less.

7. The chloroprene rubber composition according to claim 1, wherein the active zinc white has a composite structure having a core body and a zinc oxide layer covering the surface partially or entirely.

8. The chloroprene rubber composition according to claim 1, wherein the core body of the active zinc white is made of at least one inorganic salt selected from the group consisting of calcium carbonate, calcium hypochlorite, magnesium carbonate, magnesium oxide, and magnesium hydroxide.

9. A vulcanized molded article obtained by vulcanizing and molding the chloroprene rubber composition according to claim 1.

10. An anti-vibration rubber comprising the vulcanized molded article according to claim 9.
